(19) United States
(12) Patent Application Publication
(10) Pub. No.: US 2026/0270895 A1
(43) Pub. Date: Sep. 10, 2026

(54) ADVANCED ANTENNA SYSTEM COEXISTENCE

(71) Applicant: Telefonaktiebolaget LM Ericsson (publ), Stockholm (SE)

(72) Inventors: Henrik ASPLUND, STOCKHOLM (SE); Erik LARSSON, UPPSALA (SE); Magnus LUNDEVALL, SOLNA (SE); Roland SMITH, NEPEAN (CA)

(73) Assignee: Telefonaktiebolaget LM Ericsson (publ), Stockholm (SE)

(21) Appl. No.: 19/166,387

(22) PCT Filed: Mar. 17, 2023
(86) PCT No.: PCT/SE2023/050234

§ 371 Date: Sep. 17, 2025

(51) Int. Cl. H04W 52/42; H04B 7/0408; H04B 7/06; H04W 52/36

(52) U.S. Cl. CPC H04W 52/42; H04B 7/0408; H04B 7/0617; H04W 52/367

(57) ABSTRACT

The present disclosure provides a method, performed by a network node, for spatial control of transmission of radio beams. The network node determines a set of radio beam pairs, comprising vertically and horizontally polarized radio beams, to be transmitted by the network node. For each radio beam pair in the determined set of radio beam pairs, when a difference between a first and a second value of radiated power is above a threshold, transmitting the horizontally polarized radio beam with a reduced transmission power compared to the vertically polarized radio beam and otherwise, transmitting the radio beam pair with equal transmission power wherein the first value of radiated power indicates an estimated interference of the horizontally polarized beam with a radio device, and the second value of radiated power indicates an estimated interference of the vertically polarized beam with the radio device.

### TECHNICAL FIELD

The present disclosure relates to a method for spatial control of transmission of radio beams. The present disclosure also relates to a network node, a computer program and a computer program product comprising the computer program, to carry out a method for spatial control of transmission of radio beams.

### BACKGROUND

Radio frequency spectrum is regulated on a regional, national and global level to allow coexistence of multiple services in different frequency bands of the frequency spectrum. Before allocating a frequency band to a service or licensing to an operator, sharing and coexistence studies are performed to ensure that different services do not interfere with each other in ways that cause unacceptable degradation of the services. The outcome of such studies is used to set conditions on frequency band allocations, for example, conditions on maximum radiated power or Effective Isotropic Radiated Power (EIRP), conditions on out of band emission, requirements for radiation pattern masks, geographical exclusion zones, etc. Unnecessary strict conditions on frequency band allocations may prevent efficient utilization of the frequency spectrum. An important case of interference is the potential of terrestrial wireless cellular network to interfere with an aircraft, more specifically the potential of terrestrial wireless cellular network to interfere with the functioning of an altimeter of an aircraft.

An altimeter or a radar altimeter is a device, comprised in an aircraft, for measuring altitude using radio waves. The altimeter transmits a radio wave towards a ground surface. The altimeter receives the radio wave reflected back from the ground surface. To calculate the altitude at which the aircraft is at from the ground surface, the altimeter uses the time taken for a transmitted radio signal to reflect from the ground surface back to the aircraft. Radio altimeters operate at 4200-4400 MHz and most altimeters employ Frequency modulated continuous wave, FMCW, transmitters and receivers to determine altitude as a function of the frequency difference between transmitted and received radio waves. These systems employ separate transmit and receive horizontally polarized antennas on the fuselage of the aircraft. FIG. 1 is an example of an aircraft with redundant radio altimeter transmitter and receiver antenna pairs. RAD ALT #1 TX is a transmitter antenna of the first altimeter and RAD ALT #1 RX is a receiver antenna of the first altimeter. RAD ALT #2 TX is a transmitter antenna of the second altimeter and RAD ALT #2 RX is a receiver antenna of the second altimeter.

The current issue of terrestrial wireless cellular network interference to aircraft has been shown to be one of out-of-band blocking caused by poor selectivity of radio altimeters, many of which were designed before the advent of cellular technologies. While radio altimeters operate in the frequency range of 4200-4400 MHz, the limited or in some cases, absence of bandpass filters makes these devices highly sensitive to radio signals which may be hundreds of MHz away in the frequency spectrum. Recent concerns regarding C-band radio operating at 3700-3800 MHz has highlighted this issue of radio altimeter not blocking or not filtering the power radiated by the C-band radio operating at 3700-3800 MHz. Power radiated by the C-band radio operating at 3700-3800 MHz can be received by the radio altimeter and this power is called out-of-band power.

Radio altimeter blocking varies with the received level of out-of-band power. The out-of-band power is proportional to the inverse square of the distance to terrestrial wireless cellular network towers. This pathloss distance is typically minimized in/around airports, and most importantly the distance is minimal in the “final approach box” (FAB). FAB defines the zone or area used by the aircraft when they approach runway during their landing procedures.

Existing published cellular technologies employ several methods to mitigate the issue of cellular interference with aircrafts:
Frequency guard bands, barring terrestrial wireless cellular network from using frequencies adjacent to the 4200-4400 MHz band. In Japan, a 100 MHz guard band has been required, and in the USA, a guard band of 220 MHz is being employed.
Exclusion zones, prohibiting the use of cellular infrastructure transmitters, which operate in nearby frequency bands, within a defined region around airports. This is used, for example, in USA, France and Canada.
Protection zones, with highly restrictive spatial and power limits on cellular infrastructure transmitters deployed around airports. These zones protect aircrafts on their landing approach and extend up to 8 km from each end of each runway. In the USA, circular areas extending 5 miles around major airports are defined as protected zones where cellular transmitters must comply with stringent antenna elevation masks to minimize skyward radiated power.
Nationwide spatial elevation restrictions and power limits. In the USA, restrictions have been adopted limiting nationwide cellular radiated power from −65 dBm/MHz to −62 dBm/MHz. In Canada, cellular transmitters are prohibiting from up-tilting antenna beams above the horizon.

Proposed radio altimeter technologies include two options to mitigate the issue of cellular interference:
Retrofitting existing radio altimeters with improved out-of-band filtering, or new radio altimeter designs which include filtering and more recent filtering technology advances. Retrofitting existing altimeters with new filters will take at least a year to achieve consensus on requirements, followed by several years to upgrade the fleet.
Introducing new radio altimeter models further extends the availability requiring standards development, product design, field evaluation and fleet upgrades, and may take a decade.

There is no global standard for these mitigations. These mitigation methods leverage on existing network equipment configuration and capabilities but are wasteful of spectrum as they exclude wireless cellular networks in/around airports, and limit service providers from deploying network infrastructure equipment nationally for optimal coverage and capacity.

### SUMMARY

An object of the invention is to mitigate cellular interference, caused by a transmission of radio beams from a network node, to a radio device.

According to a first aspect of the invention, a method is provided for spatial control of transmission of radio beams. The method is performed by a network node. The method comprises determining a set of radio beam pairs to be transmitted by the network node wherein one radio beam in a radio beam pair is to be transmitted as a horizontally polarized radio beam and the other radio beam in the radio beam pair is to be transmitted as a vertically polarized radio beam. For each radio beam pair in the determined set of radio beam pairs, when a difference between a first and a second value of radiated power is above a threshold, transmitting the horizontally polarized radio beam with a reduced transmission power compared to the vertically polarized radio beam and otherwise, transmitting the radio beam pair with equal transmission power. The first value of radiated power indicates an estimated interference of the horizontally polarized beam with a radio device, and the second value of radiated power indicates an estimated interference of the vertically polarized beam with the radio device.

According to a second aspect of the invention, there is presented a network node in a wireless communication network. The network node is configured to determine a set of radio beam pairs to be transmitted by the network node wherein one radio beam in a radio beam pair is to be transmitted as a horizontally polarized radio beam and the other radio beam in the radio beam pair is to be transmitted as a vertically polarized radio beam. For each radio beam pair in the determined set of radio beam pairs, when a difference between a first and a second value of radiated power is above a threshold, the network node is configured to transmit the horizontally polarized radio beam with a reduced transmission power compared to the vertically polarized radio beam and otherwise, transmit the radio beam pair with equal transmission power. The first value of radiated power indicates an estimated interference of the horizontally polarized beam with a radio device, and the second value of radiated power indicates an estimated interference of the vertically polarized beam with the radio device.

According to a third aspect of the invention, there is presented a computer program comprising instructions which when run by a processor of a network node, causes the network node to perform a method according to any of the embodiments of the first aspect.

According to a fourth aspect of the invention, there is presented a computer program product which comprises a computer readable storage medium on which a computer program according to the third aspect is stored.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF DRAWINGS

Features and advantages of the invention, will be better understood through the following illustrative and non-limiting detailed description of embodiments of the invention, with reference to the appended drawings, in which:

FIG. 1 shows an example of an aircraft.

FIG. 2 shows a network node.

FIGS. 3a and 3b are flow charts illustrating method steps.

FIG. 4 depicts radio beams that can be transmitted by a network node.

FIGS. 5 and 6 depict polarization control matrices.

FIG. 7 shows reflection gain, for a medium dry ground, with respect to the angle of incidence.

FIG. 8a shows an example of interference assessment for a radio beam with horizontal polarization.

FIG. 8b shows an example of interference assessment for a radio beam with vertical polarization.

FIG. 9 depicts the network node.

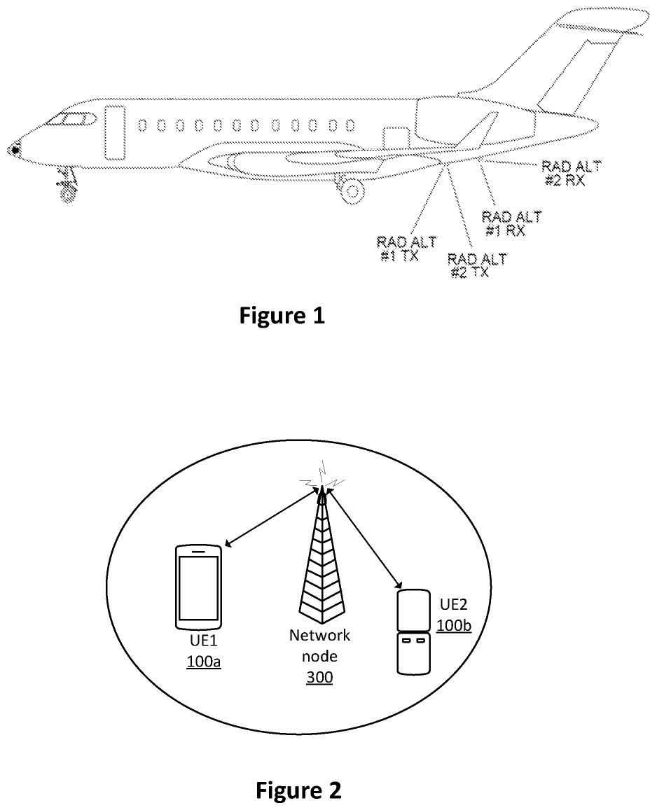

All the figures are schematic, not necessarily to scale, and generally only show parts which are necessary in order to elucidate the invention, wherein other parts may be omitted or merely suggested.

### DETAILED DESCRIPTION

Examples of the disclosure present a network node and a method performed by the network node for spatial control of transmission of radio beams. Interference refers to interaction of a radio beam or a radio signal transmitted by the network node with a functioning of a radio device, causing the device functioning to degrade in an environment where the radio beam is transmitted. Interference can occur when the radio beam or radio signal transmitted by the network node interact with radio signals transmitted and/or received during the functioning of the device. A radio altimeter is an example of a radio device whose functioning is affected by the radio beams transmitted by the network node. The interaction can result in degradation of signal quality of radio signals transmitted and/or received by the network node and/or the altimeter, increased errors in data transmission by the network node and/or the altimeter, and even complete loss of communication of the network node and/or the altimeter. Some radio devices such as radio altimeters use antennas that are horizontally polarized. Radio altimeter antennas are less sensitive to vertically polarized radio beams and would largely reject vertically polarized radio beams. The method performed by the network node enables the network node to mitigate interference with the functions of a radio altimeter of an aircraft by transmitting horizontally polarized radio beams with a reduced transmission power compared to vertically polarized radio beams.

FIG. 2 shows a network node 300 in wireless communication with some user equipment (UE) 100a and 100b, wherein embodiments presented herein can be implemented. As used herein, the network node 300 refers to equipment capable, configured, arranged and/or operable to communicate directly or indirectly with UE (100a or 100b), and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). The network node may be capable of transmitting radio beams.

As used herein, the UE 100a or 100b refers to a device capable, configured, arranged and/or operable to communicate wirelessly with network nodes (300) and/or other UEs (100a or 100b). Examples of a UE include, but are not limited to, a smart phone, mobile phone, cell phone, voice over IP (VoIP) phone, wireless local loop phone, personal digital assistant (PDA). Other examples include any UE identified by the 3rd Generation Partnership Project (3GPP), including a narrow band internet of things (NB-IoT) UE, a machine type communication (MTC) UE, and/or an enhanced MTC (eMTC) UE. A UE in the form of an Internet of Things (IoT) device may be a device for use in one or more application domains, these domains comprising, but not limited to, home, city, wearable technology, extended reality, industrial application, and healthcare.

By way of example, the IoT device for a home, an office, a building or an infrastructure may be a baking scale, a coffee machine, a grill, a fridge, a refrigerator, a freezer, a microwave oven, an oven, a toaster, a water tap, a water heater, a water geyser, a sauna, a vacuum cleaner, a washer, a dryer, a dishwasher, a door, a window, a curtain, a blind, a furniture, a light bulb, a fan, an air-conditioner, a cooler, an air purifier, a humidifier, a speaker, a television, a laptop, a personal computer, a gaming console, a remote control, a vent, an iron, a steamer, a pressure cooker, a stove, an electric stove, a hair dryer, a hair styler, a mirror, a printer, a scanner, a photocopier, a projector, a hologram projector, a 3D printer, a drill, a hand-dryer, an alarm clock, a clock, a security camera, a smoke alarm, a fire alarm, a connected doorbell, an electronic door lock, a lawnmower, a thermostat, a plug, an irrigation control device, a flood sensor, a moisture sensor, a motion detector, a weather station, an electricity meter, a water meter, and a gas meter.

By further ways of example, the IoT device for use in a city, urban, or rural areas may be connected street lighting, a connected traffic light, a traffic camera, a connected road sign, an air control/monitor, a noise level detector, a transport congestion monitoring device, a transport controlling device, an automated toll payment device, a parking payment device, a sensor for monitoring parking usage, a traffic management device, a digital kiosk, a bin, an air quality monitoring sensor, a bridge condition monitoring sensor, a fire hydrant, a manhole sensor, a tarmac sensor, a water fountain sensor, a connected closed circuit television, a scooter, a hoverboard, a ticketing machine, a ticket barrier, a metro rail, a metro station device, a passenger information panel, an onboard camera, and other connected device on a public transport vehicle. As further way of example, the communication IoT device may be a wearable device, or a device related to extended reality, wherein the device related to extended reality may be a device related to augmented reality, virtual reality, merged reality, or mixed reality. Examples of such IoT devices may be a smart-band, a tracker, a haptic glove, a haptic suit, a smartwatch, clothes, eyeglasses, a head mounted display, an ear pod, an activity monitor, a fitness monitor, a heart rate monitor, a ring, a key tracker, a blood glucose meter, and a pressure meter.

As further ways of example, the IoT device may be an industrial application device wherein an industrial application device may be an industrial unmanned aerial vehicle, an intelligent industrial robot, a vehicle assembly robot, and an automated guided vehicle.

As further ways of example, the IoT device may be a transportation vehicle, wherein a transportation vehicle may be a bicycle, a motor bike, a scooter, a moped, an auto rickshaw, a rail transport, a train, a tram, a bus, a car, a truck, an airplane, a boat, a ship, a ski board, a snowboard, a snow mobile, a hoverboard, a skateboard, roller-skates, a vehicle for freight transportation, a drone, a robot, a stratospheric aircraft, an aircraft, a helicopter and a hovercraft.

The device needing protection from interference may be a radio altimeter on an aircraft, or generally a radio receiver on an airborne vehicle such as an airplane, a helicopter, a balloon, or a space craft such as a rocket or a satellite.

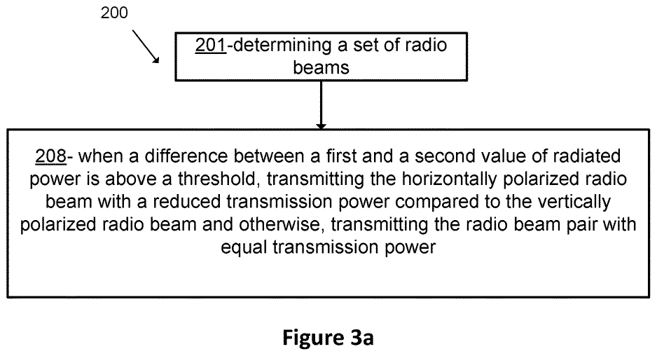

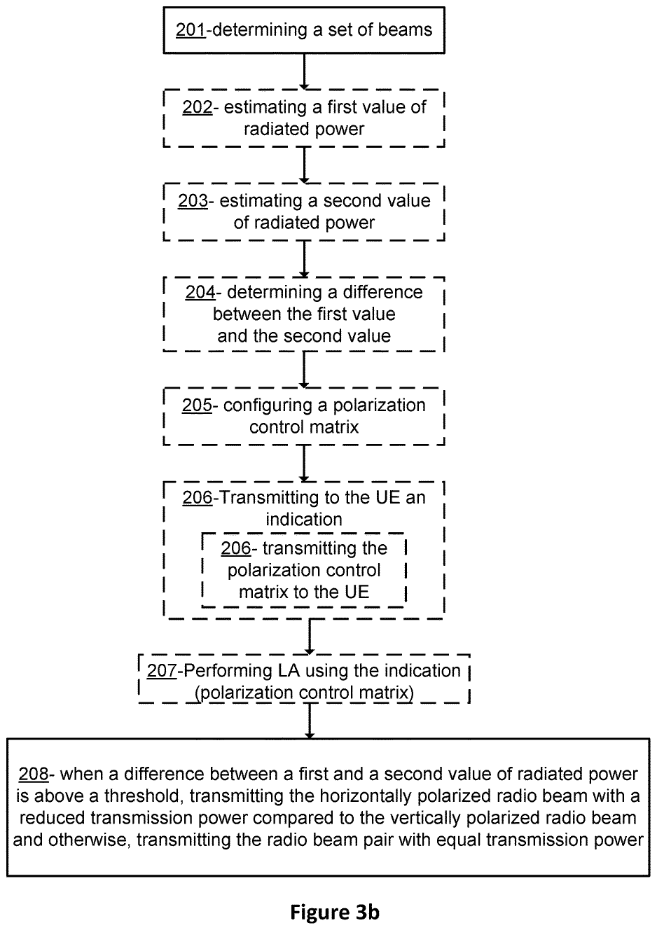

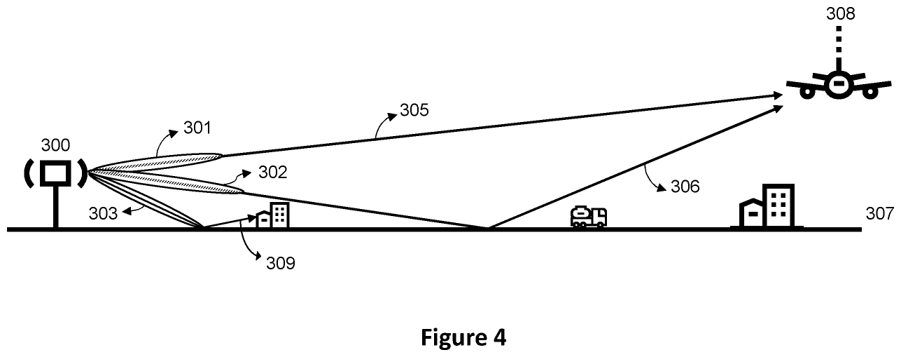

FIGS. 3a and 3b are flow charts illustrating method 200, performed by the network node 300, for spatial control of transmission of radio beams. FIG. 4 depicts radio beam pairs that can be transmitted by the network node 300.

Referring to FIGS. 3a, 3b and 4, in step 201, the method 200 comprises determining a set of radio beam pairs to be transmitted by the network node 300 wherein one radio beam in a radio beam pair is to be transmitted as a horizontally polarized radio beam and the other radio beam in the radio beam pair is to be transmitted as a vertically polarized radio beam. The horizontally polarized radio beam and the vertically polarized radio beam are to be transmitted along the same direction of transmission.

A radio beam is a directional transmission of radio waves in which a radio antenna is designed to send or receive the majority of its radio waves, in a particular direction. Radio waves can be transmitted as a beam by using an antenna that is designed to focus the radio waves in a specific direction. A technique for transmitting radio waves in a specific direction is called beamforming. Advanced antenna systems (AAS) use beamforming to improve network performance. The direction of the beam can be defined using different conventions and coordinate systems. In the following we will use an azimuth angle (φ) and an elevation angle (θ) to uniquely specify the direction. The azimuth angle specifies the horizontal beam direction with respect to a boresight of the antenna array, i.e. 0 degrees azimuth is in the boresight, positive azimuth angles are to the right of the boresight, and negative azimuth angles are to the left of the boresight. Similarly, the elevation angle specifies the vertical beam direction with respect to the boresight or the horizon, where 0 degrees elevation is in the boresight or towards the horizon, positive elevation angles are above the boresight or horizon and negative elevation angles are below the boresight or the horizon. Other conventions and coordinate systems may also be used.

Polarization of a radio beam refers to a direction of an electric field of the radio waves that may be transmitted as the radio beam. A vertically polarized radio beam is a beam of radio waves in which the electric field of the radio waves is oriented in a vertical direction. This means that the electric field of the radio beams oscillates on a vertical plane, orthogonal to the direction of propagation of the radio waves. A horizontally polarized radio beam is a beam of radio waves in which the electric field is oriented in a horizontal direction. This means that the electric field of the radio waves oscillates in a horizontal plane, perpendicular to the direction of propagation of the radio waves. Horizontal and vertical polarization are orthogonal to each other, and orthogonal to the direction of propagation of the radio waves.

A dual-polarized radio beam comprises a pair of radio beams that point in the same direction of transmission but have orthogonal polarizations. Different pairs of orthogonal polarizations are possible, but one such pair is vertical and horizontal polarizations. Transmitting a radio beam with dual polarization comprises transmitting the radio beam as a pair of radio beams that point in the same direction of transmission but with different polarizations, that is, with vertical and horizontal polarizations respectively. A 5th generation New Radio (5G NR) AAS base station typically has an array of dual-polarized antenna elements. By applying different amplitude and phase weights to radio waves sent from multiple antenna elements, a procedure referred to as precoding, radio beams with different polarization can be formed.

A set of radio beam pairs may comprise a first set of radio beam pairs. The first set of radio beam pairs can be determined by estimating whether the transmission of first set of beam pairs by the network node along certain directions or location causes interference to the functions of the radio device. Referring to FIG. 4, the first set of radio beam pairs may comprise radio beam pair 301, as radio beam pair 301 may be transmitted along the direction 305 and towards an aircraft 308. In FIG. 4, radio beam pair 301 comprises two radio beams (one vertically polarized and the other horizontally polarized) to be transmitted along the direction 305. In FIG. 4, for the sake of readability, the two radio beams comprised in radio beam pair 301 is represented using a single beam. The first set of radio beam pairs radiate power when transmitted. The density of power radiated by the first set of radio beam pairs may exceed an interference threshold. For example, the interference threshold can be a threshold set by government agencies. For example, the interference threshold can be a power density threshold set by government agencies, like −62 dBm/MHz set by the government USA. When the density of power radiated by the first set of radio beam pairs exceeds the interference threshold, the first set of radio beam pairs may interfere with the functions of the radio altimeter comprised in the aircraft 308.

The interference to the functions of the radio device, for example radio altimeter, that may be caused due to transmission of radio beams towards a direction of an aircraft can be referred to as line-of-sight interference. The transmission of radio beam pair 301 causes such a line-of-sight interference.

The first set of radio beam pairs may comprise a full set of radio beam pairs to be transmitted by the network node 300. A full set of radio beam pairs may refer to all the radio beam pairs that a network node can transmit. For example, in FIG. 4, all the radio beam pairs that the network node 300 may transmit can comprise radio beam pairs 301, 302, 303. In FIG. 4, radio beam pair 302 comprises two radio beams (one vertically polarized and the other horizontally polarized) to be transmitted along the same direction of transmission. In FIG. 4, for the sake of readability, the two radio beams comprised in radio beam pair 302 is represented using a single beam. Similarly, radio beam pair 303 comprises two radio beams (one vertically polarized and the other horizontally polarized) to be transmitted along the same direction of transmission. In FIG. 4, for the sake of readability, the two radio beams comprised in radio beam pair 303 is represented using a single beam. The first set of beam pairs may comprise radio beam pairs 301, 302 and 303. The first set of radio beam pairs may comprise the full set of radio beam pairs to be transmitted by the network node 300 but may exclude radio beam pairs that point in favourable directions. For example, the first set of radio beam pairs may exclude radio beam pairs 302 and 303 as they are not directed to be transmitted directly towards the aircraft. The first set of radio beam pairs may comprise the full set of radio beam pairs to be transmitted by the network node but may exclude radio beam pairs that have low antenna gain towards the aircraft. Low antenna gain towards the aircraft can be an antenna gain level that is lower than a maximum antenna gain. For example, a low antenna gain can be an antenna gain that is 10 dB lower than the maximum antenna gain. The first set of radio beam pairs may comprise the full set of radio beam pairs to be transmitted by the network node but may exclude radio beam pairs that have low sidelobe levels towards the aircraft. Low sidelobe level towards the aircraft can be a sidelobe level that is lower than a maximum side lobe level of the antenna.

A set of radio beam pairs may comprise a second set of radio beam pairs to be transmitted by the network node. The second set of radio beam pairs can be reflected by a ground surface or any other horizontal surface when transmitted and may produce reflected radio beam pairs. The second set of radio beam pairs can be determined by estimating whether the reflected radio beam pairs produced due to the transmission of the second set of radio beam pairs causes interference to the functions of the radio altimeter. For example, as shown in FIG. 4, radio beam pairs 302 and 303 may produce reflected beam pairs when transmitted. Radio beam pair 302 may produce a reflected beam pair along the direction 306 and towards the aircraft 308. The second set of radio beam pairs may comprise radio beam pairs 302 and 303. Reflected radio beam pairs may interfere with the functions of the radio altimeter. The density of power radiated by the reflected radio beam pairs may exceed the interference threshold and the reflected radio beam pairs may interfere with the functions of the radio altimeter comprised in the aircraft 308.

The estimation of whether the reflected radio beam pairs produced causes interference to the functions of the radio device, for example radio altimeter, may comprise one or more estimation parameters. Carrier frequency of the second set of radio beam pairs can be an estimation parameter. Electric properties of the ground surface can be an estimation parameter. Angle of elevation (θ), that is, an angle at which the second set of radio beam pairs are transmitted, can be an estimation parameter. Angle of reflection, that is, an angle at which the second set of radio beam pairs are reflected by the ground surface, can be an estimation parameter. FAB can be an estimation parameter. Information about a presence of ground clutter that may attenuate or completely block the reflected radio beam pairs, can be an estimation parameter. For example, in FIG. 4, radio beam pair 303 may produce a reflected beam pair 309 and the reflected beam pair 309 might be attenuated or completely blocked by ground clutter such as buildings or vehicles in the environment. Radio beam pair 303 can be excluded from the second set of radio beam pairs or the set of radio beam pairs, based on the estimated transmission of the radio beam pair 303 with information about a presence of ground clutter as an estimation parameter.

The interference to the functions of the radio device, for example radio altimeter, that may be caused due to reflected radio beam pairs can be referred to as ground bounce interference.

The set of radio beam pairs may comprise only the first set of radio beam pairs. The set of radio beam pairs may comprise only the second set of radio beam pairs. The set of radio beam pairs may comprise both the first and second sets of radio beam pairs.

Referring to FIGS. 3a, 3b and 4, in step 208, the method 200 comprises for each beam pair in the determined set of radio beam pairs, when a difference between a first and a second value of radiated power is above a threshold, transmitting the horizontally polarized radio beam with a reduced transmission power compared to the vertically polarized radio beam and otherwise, transmitting the radio beam pair with equal transmission power. The first value of radiated power indicates an estimated interference of the horizontally polarized beam with the radio device, for example the radio altimeter. The second value of radiated power indicates an estimated interference of the vertically polarized beam with the radio device, for example the radio altimeter, and wherein interference refers to interaction of the radio beam (horizontally polarized or vertically polarized) with a functioning of the radio device, causing the radio device functioning to degrade in an environment where the radio beam (horizontally polarized or vertically polarized) is transmitted.

For each radio beam pair in the set of radio beam pairs, the method may comprise, in step 202, estimating a first value of radiated power of the horizontally polarized radio beam when the horizontally polarized beam is transmitted.

The first value of radiated power may comprise an amount of power radiated by the horizontally polarized radio beam, when the horizontally polarized radio beam is transmitted. The first value of radiated power may comprise an amount of density of power radiated by the horizontally polarized radio beam, when the horizontally polarized radio beam is transmitted. Estimation of the first value of radiated power may be performed by estimating the transmission of the horizontally polarized radio beam. The first value of radiated power may estimate the interference that the horizontally polarized radio beam may cause when the horizontally polarized radio beam is transmitted. The amount of radiated power may estimate the potential interference that the horizontally radio beam may cause when the horizontally polarized radio beam is transmitted.

For each radio beam pair in the set of radio beam pairs, the method may comprise, in step 203, estimating a second value of radiated power of the vertically polarized radio beam when the horizontally polarized beam is transmitted. The second value of radiated power may comprise an amount of power radiated by the vertically polarized radio beam, when the vertically polarized radio beam is transmitted. The second value of radiated power may comprise an amount of density of power radiated by the vertically polarized radio beam, when the vertically polarized radio beam is transmitted. Estimation of the second value of radiated power may be performed by estimating the transmission of the vertically polarized radio beam. The second value of radiated power may estimate-the interference that the vertically polarized radio beam may cause when the vertically polarized radio beam is transmitted. The amount of radiated power may estimate the potential interference that the vertically polarized radio beam may cause when the vertically polarized radio beam is transmitted.

For each radio beam pair in the set of radio beam pairs, the method may comprise, in step 204, determining a difference between the first value of radiated power and the second value of radiated power. When the determined difference is above a threshold, the method comprises, in step 208, transmitting the horizontally polarized radio beam with a reduced transmission power compared to the vertically polarized radio beam, that is, transmitting the vertically polarized radio beam and the horizontally polarized radio beam such that the transmission power of the horizontally polarized radio beam is lower than the transmission power of the vertically polarized radio beam. In traditional dual polarization, vertically and horizontally polarized radio beams are transmitted with equal transmission power to enable a high throughput by enabling Multiple Input Multiple Output (MIMO) stream separation. Transmitting the horizontally polarized radio beam with a reduced transmission power compared to the vertically polarized radio beam, that is, transmitting the vertically polarized radio beam and the horizontally polarized radio beam such that the transmission power of the horizontally polarized radio beam is lower than the transmission power of the vertically polarized radio beam, may mitigate interference to the functions of the altimeter while still may enable a high throughput by enabling MIMO stream separation, even though the throughput obtained may not be as high as the throughput obtained using traditional dual polarization with vertically and horizontally polarized radio beams with equal transmission power. When the determined difference is below or equal to the threshold, the method comprises, in step 208, transmitting the radio beam pair with equal transmission power, that is, transmitting the vertically polarized radio beam and the horizontally polarized radio beam such that the transmission power of the vertically polarized radio beam and the transmission power of the horizontally polarized radio beam are equal to one another.

Alternatively, when the determined difference is above a threshold, the method may comprise, in step 208, reducing the transmission power of the horizontally polarized beam to zero and transmitting only the vertically polarized radio beam.

The method of 200 may further comprise configuring a polarization control matrix. The polarization control matrix may be configured in step 205 of method 200. The polarization control matrix may refer to a control interface for granular transmission power control for different polarizations. The polarization control matrix is defined as a function of beam directions, for example azimuth angle (φ) and angle of elevation (θ). Azimuth angle (φ) and angle of elevation (θ) may define the spatial direction in which a radio beam pair comprising a horizontally polarized beam and a vertically polarized radio beam can be transmitted by a network node.

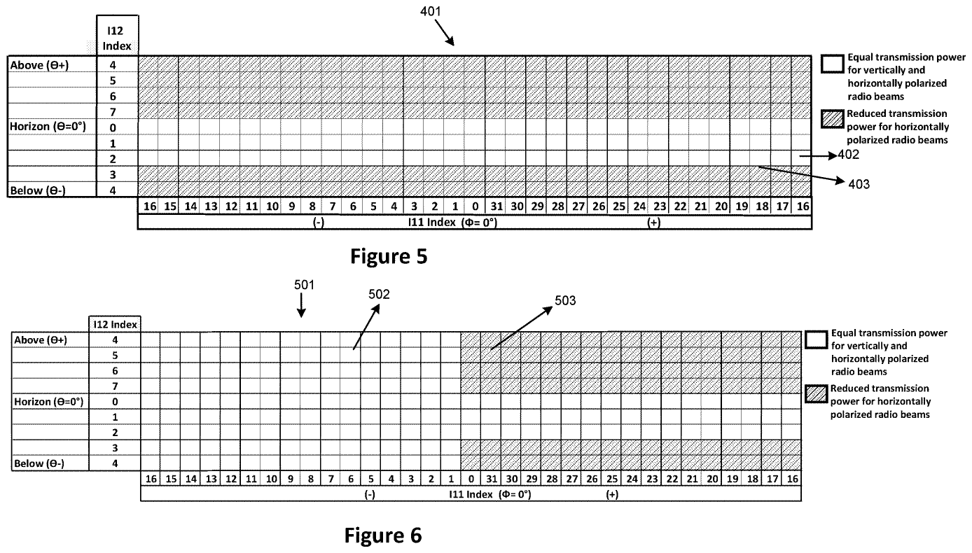

Configuring the polarization control matrix may refer to, for each spatial direction in the polarization control matrix, indicating whether there is a reduction in transmission power for one or more polarizations of the radio beam pair that is to be transmitted along that spatial direction. Configuring the polarization control matrix may refer to, for each spatial direction in the polarization control matrix, indicating whether there is a reduction in transmission power for the horizontally polarized radio beam of the radio beam pair that is to be transmitted along that spatial direction. FIGS. 5 and 6 depict polarization control matrices 401 and 501, respectively. In the polarization control matrix, 401 or 501, each spatial direction along which a radio beam pair can be transmitted, defined by an azimuth angle (φ) and an angle of elevation (θ), may have an indication whether a horizontally polarized radio beam of the radio beam pair has reduced transmission power or not based on the method 200. In FIGS. 5 and 6, index I11 may refer to different azimuth angle (φ) values. Index I11 may also refer to different quantized azimuth angle (φ) values. An index I11 value of 0 may refer to an azimuth angle φ=0°. Indices I11 between values 1-16 may refer to negative azimuth angles (φ−). Indices I11 between values 16-31 may refer to positive azimuth angles (φ+). A radio beam (vertically or horizontally polarized) with an azimuth angle according to index 16 may have two lobes, one lobe with a positive azimuth angle and another lobe with a negative azimuth angle.

Index I12 may refer to different elevation angle (θ) values. Index I12 may also refer to different quantized elevation angle (θ) values. An Index I12 value of 0 may refer to an angle of elevation θ=0°. An angle of elevation θ=0° may also be referred to as horizon. Horizon may also refer to horizon of the network node 300. Indices I12 between values 4-7 may refer to positive elevation angles (θ+). Indices I12 between values 4-7 may also refer to direction of transmission of radio beam pairs that are above the horizon. A radio beam pair that may be transmitted with a positive angle of elevation may refer to a radio beam pair transmitted above the horizon and away from a ground surface. Indices I12 between values 1-4 may refer to negative elevation angles (θ−). Indices I12 between 1-4 may also refer to direction of transmission of radio beam pairs that are below the horizon. A radio beam pair transmitted with a negative angle of elevation may refer to a radio beam pair transmitted below the horizon and towards the ground surface. A radio beam (vertically or horizontally polarized) with an angle of elevation according to index 4 may have two lobes, one lobe with a positive angle of elevation and another lobe with a negative angle of elevation.

For example, in the polarization control matrix 401, 402 may refer to a specific spatial direction along which a radio beam pair can be transmitted by the network node 300. 402 may be defined by an angle of elevation (θ) denoted by an I12 index of value 2 and an azimuth angle (φ) denoted by an I11 index of value 16. Similarly, 403 may refer to a specific spatial direction along which a radio beam pair can be transmitted by the network node 300. 403 may be defined by an angle of elevation (θ) denoted by an I12 index of value 3 and an azimuth angle (φ) denoted by an I11 index of value 18.

The polarization control matrix may be optimal for codebook-based antenna systems whereby the transmission power for each radio beam of the radio beam pair is controlled with a bit value. For example, a bit value of 0 for the spatial direction of 403 may indicate a reduced transmission power of the horizontally polarized radio beam compared to the vertically polarized radio beam of the radio beam pair that may be transmitted by the network node along the spatial direction of 403. In an embodiment, the transmission power of the horizontally polarized radio beam of the radio beam pair can be reduced to zero. A bit value of 1 for the spatial direction of 402 may indicate equal transmission power for the horizontally polarized radio beam and the vertically polarized radio beam of the radio beam pair that may be transmitted by the network node along the spatial direction of 402.

In the polarization control matrix 401 depicted in FIG. 5, according to method 200, the spatial directions above the horizon (with positive elevation angles (θ+)) may have an indication, for example using a bit value 0, such that, during transmission of radio beam pairs along the spatial directions above the horizon, transmission power of the horizontally polarized radio beams of the radio beam pairs is reduced compared to the vertically polarized radio beams of the radio beam pairs to mitigate line-of-sight interference with the functions of the radio altimeter of an aircraft. In an embodiment, the transmission power of horizontally polarized radio beams may be reduced to zero and only vertically polarized radio beams may be transmitted. For example, in FIG. 4, the spatial direction along which radio beam pair 301, that is to be transmitted above the horizon with positive angle of elevation (θ+) and towards the aircraft 308, may have an indication, for example using a bit value 0, in the polarization control matrix such that transmission power for the horizontally polarized radio beam of the radio beam pair 301 is reduced compared to the vertically polarized radio beam of the radio beam pair 301 to mitigate line-of-sight interference with the functions of the radio altimeter of the aircraft 308. In the polarization control matrix 401, the spatial directions below the horizon (with negative elevation angles (θ−)) may have an indication, for example using a bit value 0, such that, during transmission of radio beam pairs along the spatial directions below the horizon, transmission power for the horizontally polarized radio beams of the radio beam pairs is reduced compared to the vertically polarized radio beams of the radio beam pairs to mitigate ground bounce interference with the functions of the radio altimeter of an aircraft. In an embodiment, the transmission power of horizontally polarized radio beams may be reduced to zero and only vertically polarized radio beams may be transmitted. For example, in FIG. 4, radio beam pair 302 may be transmitted below the horizon with negative elevation angle (θ−) and may produce reflected beam pair that can interfere with the functions of the radio altimeter of the aircraft 308. The spatial direction along which radio beam pair 302 may be transmitted may have an indication, for example using a bit value 0, in the polarization control matrix such that transmission power for the horizontally polarized radio beam of the radio beam pair 302 is reduced compared to the vertically polarized radio beam of the radio beam pair 302 to mitigate ground bounce interference with the functions of the radio altimeter of the aircraft 308. In FIG. 4, in the polarization control matrix 401, some of the spatial directions along which radio beam pairs are to be transmitted, may have an indication, for example using a bit value 0, such that, during transmission of the radio beam pairs along those some spatial directions, transmission power of the horizontally polarized radio beams of the radio beam pairs is reduced compared to the vertically polarized radio beams of the radio beam pairs to mitigate line-of-sight interference or ground bounce interference with the functions of the radio altimeter of the aircraft. Other spatial directions along which radio beam pairs are to be transmitted radio beam pairs may have an indication, for example using a bit value 1, in the polarization control matrix 401, such that, during transmission of the radio beam pairs along those other spatial directions, transmission power of the horizontally polarized radio beams of the radio beam pairs is equal to the transmission power of the vertically polarized radio beams of the radio beam pairs.

Polarization control matrix 501 depicted in FIG. 6 is similar to that of the polarization control matrix 401 depicted in FIG. 5. In FIG. 6, the spatial directions of transmission defined by positive azimuth angles (φ+) and both positive and negative elevation angles, for example spatial direction of transmission denoted by 503, may overlap with a protected area such as, FAB. Thus, in the polarization matrix 501, an indication, for example using a bit value 0, can be provided, such that, during the transmission of the radio beam pairs along the spatial directions with positive azimuth angles (φ+) both above and below the horizon, transmission power of the horizontally polarized radio beams of the radio beam pairs is reduced compared to the vertically polarized radio beams of the radio beam pairs. In an embodiment, the transmission power of horizontally polarized radio beams may be reduced to zero and only vertically polarized radio beams may be transmitted. The direction of transmission defined by negative azimuth angles (φ−) and both positive and negative elevation angles, for example direction of transmission denoted by 502, may not overlap with the FAB. Thus, in the polarization matrix 501, an indication, for example using a bit value 1, can be provided, such that, during the transmission of the radio beam pairs along the spatial directions with negative azimuth angles (φ−) both above and below the horizon, transmission power of the horizontally polarized radio beams of the radio beam pairs is equal to the transmission power of the vertically polarized radio beams of the radio beam pairs.

In an embodiment, the polarization control matrix may have more than one bit per spatial direction to encode the reduction in transmission power of the horizontally polarized radio beam to be transmitted along that spatial direction.

Most wireless systems use Link Adaptation (LA), where the format of transmissions is dynamically adjusted to make the most of the wireless channel conditions and achieve higher spectral efficiency. Such adjustments may include changing the modulation and coding scheme (MCS), the number of MIMO layers to transmit, and/or the precoders (e.g. beams or polarizations). For the downlink in e.g. LTE and NR, LA decisions are taken by the network node based on preferences reported by the UE via Channel State Information (CSI) reports that can contain e.g. a Channel Quality Indicator (CQI) report, a Precoder Matrix Indicator (PMI) and/or a Rank Indicator (RI). The CSI reporting is configured by the network node, where the configuration may include which resources the UE should use for determining the CSI and how often it should be reported.

The method of 200 may further comprise, in step 206, transmitting an indication comprising reduction in transmission power of the horizontally polarized radio beam to the UE (100a or 100b). The transmitted indication can be used by the UE to determine CSI for the communication with the network node. The method of 200 may further comprise, in step 207, performing LA for communication with the UE (100 a, 100b) based on the indication, that is, performing LA for communication with the UE (100a, 100b) based on the reduction in transmission power of the horizontally polarized radio beam. In an embodiment, the transmitted indication may comprise the polarisation control matrix (401 or 501). The presented step 207 can be implemented in base stations without impacting existing RAN operation. In particular, the implementation of the embodiments can be made transparent to the UEs by adapting the UEs accordingly. However, in embodiments of the invention, one can envision enhancements that may impact the UE behaviour, one such example could be link adaptation (LA). The Channel Quality Indicator (CQI) required for LA can be determined using the polarization control matrix (401 or 501). Hence, if a Channel State Information (CSI) reported by the UE indicates a preference to use a beam and a polarization that should be avoided according to the polarization control matrix, the base station may override the preference for the polarization reported by the UE in CSI report and may accordingly adjust the CQI to achieve the best link performance with the available polarization for the UE. One approach that may improve and/or simplify the LA would be to enhance the existing standardized codebook subset restriction framework. The UE can be informed that certain codewords in the codebook, that may refer to a polarization that is to be avoided, can be prohibited and may not be part of the CSI report. The problem with the existing codebook subset restriction framework is that one cannot make special restrictions conditioned on a selected beam. For example, according to existing codebook subset restriction framework when a radio beam pair is excluded, then the radio beam pair is excluded for all polarizations, and conversely, if a polarization is excluded, then the polarization is excluded for all radio beam pairs. In one embodiment, the current codebook subset restriction framework can be enhanced by restricting or allowing polarization for each radio beam pair. Configuring polarization for each radio beam pair can be done by extending Radio Resource Control (RRC) signalling to include information regarding the radio beam pairs for which there may be restrictions on the polarization. Most standardized codebooks may be based on a so-called product structure where the precoding matrix W may consist of two parts W=W1×W2, where W1 may relate to properties like directions of transmission (or different beam pairs to be transmitted) and W2 may refer to properties like polarization. The restriction on W2 can be conditioned on W1, that is, the polarization of a radio beam pair can be configured depending on the specific beam pair or specific direction of transmission of the radio beam pair. As discussed with respect to FIGS. 5 and 6, the restriction can be a bit value (for example, 0) indicating an uneven transmission power allocation in a radio beam pair, so that a specific polarization is only partly prohibited, that is, horizontally polarized radio beam of the radio beam pair is partly prohibited by reducing the transmission power of the horizontally polarized radio beam in comparison to the vertically polarized radio beam of the radio beam pair. Alternatively, the restriction can be a bit value (for example, 0) indicating a complete prohibition of a specific polarization, that is, for a specific beam pair horizontally polarized radio beam of the radio beam pair is completely prohibited by reducing the transmission power of the horizontally polarized radio beam to zero and transmitting only the vertically polarized radio beam of the radio beam pair. Further, a bit field may be added in the Downlink Control Information (DCI) to facilitate the implementation of the presented embodiments. The bit field may be used to indicate whether the restriction configured by codebook subset restriction framework should be applied or not in the next, or following, scheduling occasion(s) of transmission.

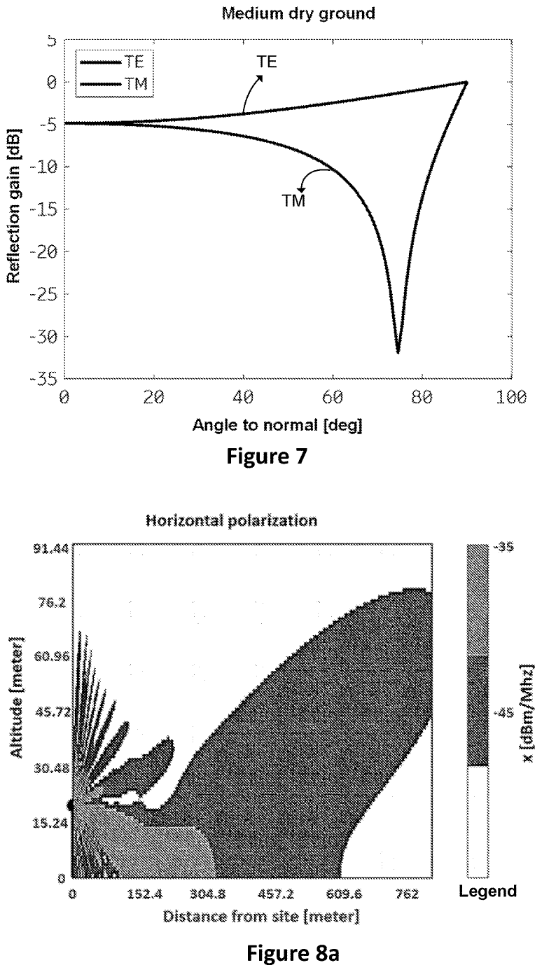

Both line-of-sight and ground bounce interference to radio altimeters by a radio beam pair can be avoided by reducing the transmission power of the horizontally polarized radio beam of the radio beam pair compared to the vertically polarized radio beam of the radio beam pair and thus, enabling the coexistence of AAS and radio altimeters. Or, both line-of-sight and ground bounce interference to radio altimeters by a radio beam pair can be avoided by reducing the transmission power of horizontally polarized radio beam to zero and only transmitting vertically polarized radio beam and thus, enabling the coexistence of AAS and radio altimeters. Especially, when a vertically polarized radio beam hits a ground surface at a Brewster angle, the reflection of the vertically polarized radio beam is minimized or eliminated because the electric field component of the vertically polarized radio beam perpendicular to the ground surface is zero at the Brewster angle. The Brewster angle is the angle of incidence, with respect to the ground surface normal, at which the reflection of a radio beam is minimized or eliminated. In FIG. 7, reflection gain, for a medium dry ground, with respect to the angle of incidence or angle to ground surface normal for two polarizations is shown, where TM represents vertical polarization and TE represents horizontal polarization. Reflection gain refers to a difference in power between an incident radio beam and the corresponding reflected radio beam reflected by a ground surface. Reflection gain is well-known to be dependent on the polarization of the radio beam with respect to the orientation of the surface normal and the direction of incidence. The exact shape of the curves depends on ground reflection coefficient, but a general trend shows a sharp loss of reflection gain for the vertical polarization at a particular angle, the so-called Brewster angle. The ground reflection coefficient is a measure of how much of a radio beam is reflected off a ground surface. The ground reflection coefficient depends on the dielectric constant and the conductivity of the ground surface, as well as the frequency and polarization of the radio beam. As shown in FIG. 7, there is a certain angular range where the reflection gain is much stronger for horizontal polarization than for vertical polarization. In this example, at about 75±10° the difference between the two polarizations is 10 dB or more. Therefore, when transmitting a radio beam pair at Brewster angle or at an angle that can be in the range of Brewster angle (for example, 75±10°), reducing the transmission power of the horizontally polarized radio beam of the radio beam pair compared to the vertically polarized radio beam of the radio beam pair, or, reducing the transmission power of the horizontally polarized radio beam of the radio beam pair to zero may reduce the potential interference to radio altimeters caused by the reflected radio beam pair.

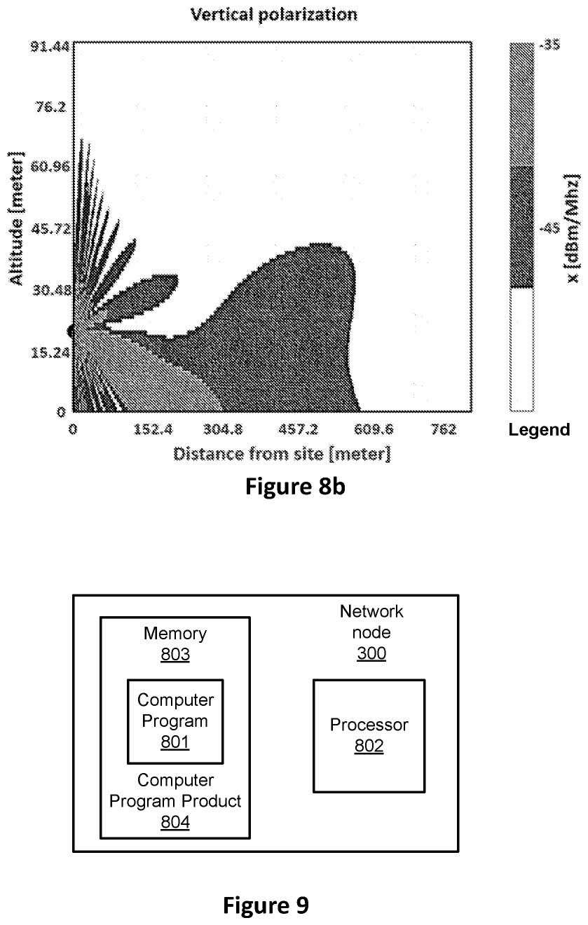

FIG. 8a shows an example of interference assessment for a horizontally polarized radio beam that is pointing downwards by 6 degrees from the horizon. FIG. 8 b shows an example of interference assessment for a vertically polarized radio beam. Spatial areas in the graph where the power density in the beam exceeds some power density thresholds, such as −45 dBm/MHz and −35 dBm/MHz are indicated by a legend. In FIG. 8a, the horizontally polarized radio beam is transmitted from a base station which is at an altitude of 20 m above ground. The power density in this beam exceeds a −45 dB/MHz threshold more than 762 meters horizontally from the base station and up to 76.2 meters (altitude) above ground. The power density in this beam exceeds a −35 dBm/MHz threshold (or interference threshold) in a smaller region.

In FIG. 8 b, the vertically polarized radio beam that is pointing downwards by 6 degrees from the horizon is transmitted from a base station which is at an altitude of 20 m above ground. The power density in this beam exceeds −45 dBm/MHz in a region which extends less than 609.6 meters horizontally from the base station and less than 76.2 meters (altitude) above ground. The power density in this beam exceeds a −35 dBm/MHz threshold (or interference thresholds) in a smaller region. As seen from FIGS. 8a and 8b, the density of power radiated by the horizontally polarized beam has a wider spatial distribution than the density of power radiated by the vertically polarized beam. The difference in spatial power density distribution between the two polarizations is due to the different ground reflection coefficients. Polarization of radio beams influences the spatial distribution of power radiated by the radio beams exceeding the interference thresholds. Therefore, vertically polarized radio beams have reduced spatial distribution of radiated power exceeding the interference thresholds when compared to horizontally polarized radio beams, as shown in FIG. 8b.

Another advantage of vertically polarized radio beams, compared to horizontally polarized radio beams, is a reduction in atmospheric ducting. Atmospheric ducting is a phenomenon that occurs when the refractive index of the atmosphere changes with altitude in a way that allows radio beams to be trapped in a layer of the atmosphere and to travel long distances without being scattered or absorbed. Atmospheric ducting can cause radio beams to be transmitted over long distances, beyond the normal range of distance, and can cause interference with other radio systems, such as radio altimeters. While atmospheric ducting is not anticipated to be a key factor for radio altimeters, it cannot be ruled out. Atmospheric ducting is similar to ground bounce, where dielectric boundaries of the atmosphere reflect horizontally polarized radio beams more effectively than vertically polarized radio beams and can lead to pathloss lower than 1/r² or inverse square of the distance r to an antenna site or lower than 20 dB/decade for horizontally polarized radio waves. Embodiments presented here provide an advantage of limiting atmospheric ducting by reducing the transmission power of the horizontally polarized radio beam compared to the vertically polarized radio beam, or, reducing the transmission power of the horizontally polarized radio beam to zero.

The suppression of horizontally polarized radio beams and transmission of vertically polarized radio beams can protect the functions of a radio altimeter from line-of-sight interference, ground bounce interference, and atmospheric ducting interference.

In the following, a network node 300 in a wireless communication network, performing a method 200 for spatial control of transmission of radio beams is presented. The network node being configured to determine a set of radio beam pairs to be transmitted by the network node 300, wherein one radio beam in a radio beam pair is to be transmitted as a horizontally polarized radio beam and the other radio beam in the radio beam pair is to be transmitted as a vertically polarized radio beam. For each radio beam pair in the determined set of radio beam pairs, when a difference between a first and a second value of radiated power is above a threshold, the network node is configured to transmit the horizontally polarized radio beam with a reduced transmission power compared to the vertically polarized radio beam and otherwise, the network node 300 is configured to transmit the radio beam pair with equal transmission power. The network node 300 being configured to reduce the transmission power of the horizontally polarized beam to zero when the difference between the first and the second value of radiated power is above the threshold. The network node (300) being configured to estimate the first value of radiated power indicating the estimated interference of the horizontally polarized beam with the radio device. The network node (300) being configured to estimate a second value of radiated power indicating the estimated interference of the vertically polarized beam with the radio device. The network node (300) being configured to determine the difference between the first value of radiated power and the second value of radiated power. The network node 300 further being configured to configure a polarization control matrix (401, 501) comprising spatial directions of transmission for the transmission of radio beam pairs according to one or more embodiments of the method 200. The network node 300 further being configured to transmit an indication comprising reduction in transmission power of the horizontally polarized radio beam to the UE (100a or 100b) according to one or more embodiments of the method 200. The network node 300 further being configured to perform LA with the UE (100a, 100b) using the indication according to one or more embodiments of the method 200, and wherein the indication comprises the polarization control matrix (401 or 501). The network node 300 may be configured to perform a method according any of the embodiments of the method 200 described above.

FIG. 9 depicts the network node 300. The network node 300 comprises a processing circuitry 802; and a memory 803 coupled with the processing circuitry 802, wherein the memory includes instructions 801 that when executed by the processing circuitry 802 causes the network node to perform operations according to method 200 and embodiments thereof. The processing circuitry is exemplified as a processor 802 in FIG. 9. The network node 300 may comprise one or more processors. The instructions are exemplified as a computer program 801 comprising computer-executable instructions in FIG. 9. The memory 803 stores the computer program 801 comprising computer-executable instructions. The computer program 801 comprising the computer-executable instructions is executed on the processor 802 causing the network node 300 to perform operations according to method 200 and embodiments thereof. The computer program 801 comprising the computer-executable instructions may be loaded from the memory 803 and executed by the processor 802 causing the network node 300 to perform operations according to method 200 and embodiments thereof. FIG. 9 shows a computer program product 804 which comprises a computer readable storage medium on which the computer program 801 is stored.

The person skilled in the art realizes that the invention by no means is limited to the embodiments described above. On the contrary, many modifications and variations are possible within the scope of the appended claims.

1. A method for spatial control of transmission of radio beams, the method, performed by a network node, comprising:
determining a set of radio beam pairs to be transmitted by the network node wherein one radio beam in a radio beam pair is to be transmitted as a horizontally polarized radio beam and the other radio beam in the radio beam pair is to be transmitted as a vertically polarized radio beam; and
for each radio beam pair in the determined set of radio beam pairs, when a difference between a first and a second value of radiated power is above a threshold, transmitting the horizontally polarized radio beam with a reduced transmission power compared to the vertically polarized radio beam and otherwise, transmitting the radio beam pair with equal transmission power,
wherein the first value of radiated power indicates an estimated interference of the horizontally polarized beam with a radio device and the second value of radiated power indicates an estimated interference of the vertically polarized beam with the radio device.

2. The method according to claim 1, wherein the radio device is a radio altimeter.

3. The method according to claim 1, wherein when the difference between the first and the second value of radiated power is above the threshold, reducing the transmission power of the horizontally polarized beam to zero and transmitting only the vertically polarized radio beam.

4. The method according to claim 1, further comprising:
configuring a polarization control matrix comprising spatial directions of transmission for the transmission of the radio beam pairs.

5. The method according to claim 4, wherein the polarization control matrix is defined as a function of azimuth angle and angle of elevation.

6. The method according to claim 4, wherein the polarization control matrix has more than one bit per spatial direction to encode the reduction in transmission power of the horizontally polarized radio beam to be transmitted along that spatial direction.

7. The method according to claim 6, further comprising:
-transmitting (206) an indication comprising reduction in transmission power of the horizontally polarized radio beam to a user equipment, UE.

8. The method according to claim 1, further comprising:
performing Link Adaptation for transmission to the UE based on the reduced transmission power of the horizontally polarized beam.

9. The method according to claim 7, wherein the indication comprises the polarization control matrix.

10. The method according to claim 1, wherein the set of beam pairs to be transmitted by the network node have directions of transmission above a horizon of the network node.

11. The method according to claim 1, wherein the set of beam pairs to be transmitted by the network node have directions of transmission below a horizon of the network node.

12. The method according to claim 1, wherein the set of beam pairs is determined based on one or more of carrier frequency of the set of beam pairs, angle of elevation of the set of beam pairs, angle of reflection of the set of beam pairs, relative permittivity and conductivity of a ground surface, presence of ground clutter, final approach box and exclusion zone requirements.

13. The method according to claim 1, further comprising:
estimating a first value of radiated power.

14. The method according to claim 1, further comprising:
estimating a second value of radiated power.

15. The method according to claim 1, further comprising:
determining a difference between the first value of radiated power and the second value of radiated power.

16. A network node in a wireless communication network, the network node being configured to:
determine a set of radio beam pairs to be transmitted by the network node wherein one radio beam in a radio beam pair is to be transmitted as a horizontally polarized radio beam and the other radio beam in the radio beam pair is to be transmitted as a vertically polarized radio beam; and
for each radio beam pair in the determined set of radio beam pairs, when a difference between a first and a second value of radiated power is above a threshold, transmit the horizontally polarized radio beam with a reduced transmission power compared to the vertically polarized radio beam and otherwise, transmit the radio beam pair with equal transmission power,
wherein the first value of radiated power indicates an estimated interference of the horizontally polarized beam with a radio device, and the second value of radiated power indicates an estimated interference of the vertically polarized beam with the radio device.

17. The network node according to claim 16, wherein the radio device is a radio altimeter.

18. The network node according to claim 16, wherein when the difference between the first and the second value of radiated power is above the threshold, reduce the transmission power of the horizontally polarized beam to zero and transmit only the vertically polarized radio beam.

19-21. (canceled)

22. The network node according to claim 16, further being configured to:
transmit an indication comprising reduction in transmission power of the horizontally polarized radio beam to a user equipment, UE.

23. (canceled)

24. The network node according to claim 22, wherein the indication comprises the polarization control matrix.

25-32. (canceled)
